(19) United States
(12) Patent Application Publication
(10) Pub. No.: US 2010/0157815 A1
(43) Pub. Date: Jun. 24, 2010

(54) System and Method for Transport Independent Automated Voice Solutions

(76) Inventors: Zhiqiang Qian, Holmdel, NJ (US); Paritosh Bajpay, Edison, NJ (US); Jackson Liu, Middletown, NJ (US); Michael Zinnikas, North Brunswick, NJ (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/338,181

(22) Filed: Dec. 18, 2008

(51) Int. Cl. H04L 12/26

(52) U.S. Cl. 370/244

(57) ABSTRACT

A system and method provides transport independent automated voice solutions. The method comprises receiving an indication of a network issue of a network. The network issue relates to a malfunction of a voice service provided by the network. Sub-networks of the network utilize a plurality of transmission protocols. The method further comprises determining a source of the network issue by determining a status for each of select components related to the network issue. The select components are determined by a type of the transmission protocols related to the network issue.

### BACKGROUND

A network may provide edge devices with voice services. For example, the network may enable a first user to vocally communicate via a first edge device to a second user utilizing a second edge device. In order to properly connect the first user to the second user, signals are required to be routed by the network to the appropriate destination. The signals may be received by a first network device such as a router that forwards the signals to a second network device such as a server that forwards the signals to a third network device, etc. When at least one of the components in the signal path malfunctions or functions improperly, the signals may not be properly delivered to the appropriate destination. Conventionally, a technician is required to determine the cause for the break in the signal path and further determine a way to correct the problem.

With regard to voice services, an integrated network functions in a substantially similar to the above described network. However, the integrated network may further incorporate further voice services, may include additional types of transmission means, may include a variety of other network devices, etc. The complexity of the integrated network may pose further problems when addressing a break in the signal path from the first edge device to the second edge device, particularly when different types of transmission means are used within the path. Accordingly, when at least one of the components in the signal path malfunctions or functions improperly, additional factors must be considered to determine the cause for the break as well as how to address the problem. Therefore, a highly qualified technician or multiple technicians may be assigned the task of fixing the problem. However, to fix the problem is very time-consuming and labor intensive.

### SUMMARY OF THE INVENTION

The present invention relates to a system and method for transport independent automated voice solutions. The method comprises receiving an indication of a network issue of a network. The network issue relates to a malfunction of a voice service provided by the network. Sub-networks of the network utilize a plurality of transmission protocols. The method further comprises determining a source of the network issue by determining a status for each of select components related to the network issue. The select components are determined by a type of the transmission protocols related to the network issue.

### DESCRIPTION OF THE DRAWINGS

FIG. 1 shows an integrated network according to an exemplary embodiment of the present invention.

FIG. 2 shows a method for an automated addressing of voice issues in an integrated network according to an exemplary embodiment of the present invention.

### DETAILED DESCRIPTION

The exemplary embodiments of the present invention may be further understood with reference to the following description and the appended drawings, wherein like elements are provided with the same reference numerals. The exemplary embodiments of the present invention may be related to a system and method for automating a process of solving voice issues in an integrated network by incorporating the various types of signal transmission means. In the exemplary embodiments, the present invention will be described with reference to an integrated network that includes at least two different types of signal transmission means. Furthermore, according to the exemplary embodiments of the present invention, the automated method may include initially determining where a reported problem exists and subsequently determining how to address the reported problem.

It should be noted that the exemplary embodiments of the present invention will be described with reference to an integrated network. However, those skilled in the art will understand that the exemplary embodiments of the present invention may be applied to any network that provides voice services. For example, a step requiring a determination of a type of signal transmission means may be bypassed when only a singular type of signal transmission means is used in the network.

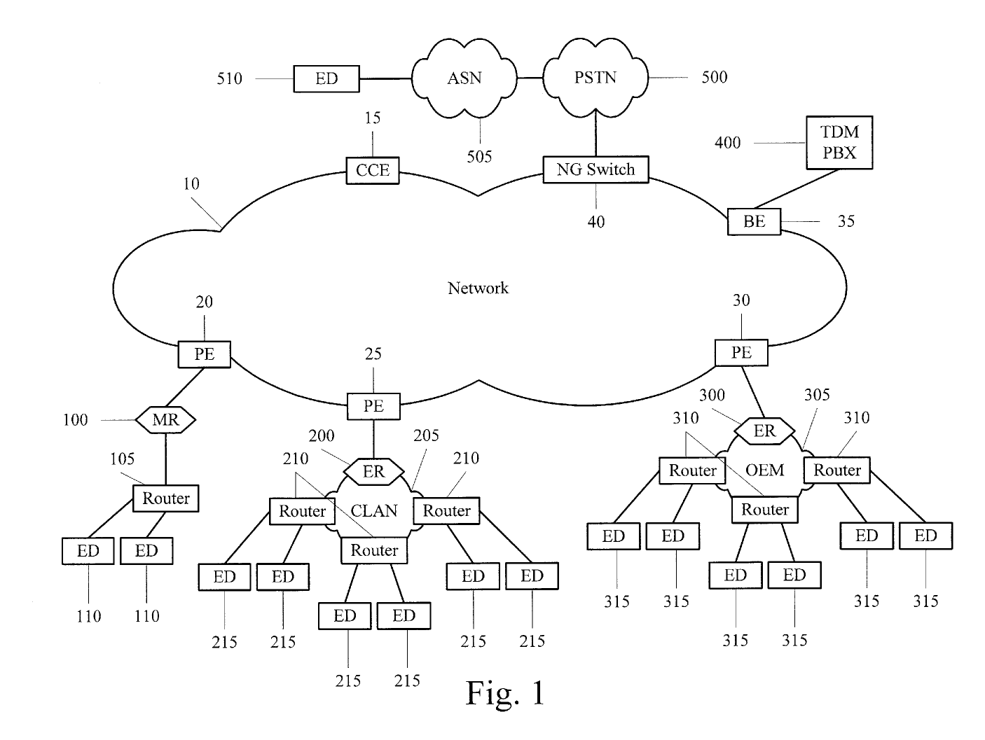

FIG. 1 shows an integrated network 10 according to an exemplary embodiment of the present invention. The integrated network 10 may enable voice services to devices associated with the integrated network 10. The integrated network 10 may include sub-networks that are also associated therewith. As illustrated in FIG. 1, the integrated network 10 may include a device to perform the automated method. The device may function in a substantially similar manner as a certified computer examiner (CCE). Therefore, the device is referred herein as a CCE 15. The CCE 15 will be described in further detail below. The integrated network 10 may further include a provider edge device (PE) 20, PE 25, PE 30, a branch exchange device (BE) 35, and a network gateway (NG) switch 40. The PEs 20, 25, 30 as well as the BE 35 and the NG switch 40 may be directly connected to the CCE 15.

The PEs 20, 25, 30 may be routers disposed between the operating area of the network 10 and a further operating area of a respective network. As illustrated, the PE 20 may be disposed between the network 10 and a managed router 100; the PE 25 may be disposed between the network 10 and an edge router (ER) 200; and the PE 30 may be disposed between the network 10 and an ER 300. The BE 35 may be a router for a private branch exchange (PBX) system and, therefore, be disposed between the network 10 and a time division multiplexing (TDM) PBX 400. The NG switch 40 may be a router to connect the network 10 to a public switch telephone network (PSTN) 500.

The MR 100 may be for any type of network configuration such as a wide area network (WAN), local area network (LAN), a wireless network, a private local area network (PLAN), etc. The network may include a router 105 and edge devices (ED) 110. Thus, the MR 100 may further be connected to the router 105 that handles signals that are received and/or transmitted to the EDs 110. Signals transmitted within the network (e.g., between the EDs 110 and the router 105; between the router 105 and the MR 100; between the MR 100 and the PE 20) may use a particular protocol. According to the exemplary embodiment of FIG. 1, the signal transmission means may be a digital subscriber line (DSL) protocol.

With reference to the ER 200, the ER 200 may be for a customer local area network (CLAN) 205. The CLAN 205 may include routers 210. Each of the routers 210 may handle signals that are received and/or transmitted to EDs 215. Signals transmitted between the CLAN 205 may also use a particular protocol. According to the exemplary embodiment of FIG. 1, the signal transmission means may be a management information system (MIS) protocol.

With reference to the ER 300, the ER 300 may be for an optical Ethernet mesh (OEM) network 305. The OEM network 305 may include routers 310. Each of the routers 310 may handle signals that are received and/or transmitted to EDs 315. Signals transmitted between the OEM network 305 may further use a particular protocol. According to the exemplary embodiment of FIG. 1, the signal transmission means may be a virtual private network (VPN) protocol.

With reference to the TDM PBX 400, the TDM PBX 400 may include an anchor PBX device and regional PBX devices. The TDM PBX 400 may be, for example, for a private enterprise to handle voice services provided for users within the TDM PBX 400 and for voice services that relate to incoming and outgoing signal transmissions from the TDM PBX 400. Signals transmitted for the TDM PBX 400 may still further use a particular protocol. According to the exemplary embodiment of FIG. 1, because the signal transmissions may be proprietary depending on the private enterprise utilizing the TDM PBX 400, the signal transmission means may be referred to herein as an On-Net protocol.

With reference to the PSTN 500, the PSTN 500 may be a conventional PSTN that enables voice services between the network 10 and further networks not associated with the network 10. Accordingly, the PSTN 500 may be connected to an access service network (ASN) 505. The ASN 505 may associate with respective EDs such as ED 510. Signals transmitted for the PSTN 500 may utilize yet another particular protocol. According to the exemplary embodiment of FIG. 1, because the signal transmissions may differ depending on the PSTN 500, the ASN 505, and the ED 510, the signal transmission means may be referred to herein as an Off-Net protocol.

It should be noted that the above description of the network 10 and the further sub-networks (e.g., network for the MR 100; the CLAN 205; the OEM network 305; the TDM PBX 400; the PSTN 500) is only exemplary. Those skilled in the art will understand that the network 10 may include further different types of networks and a respective router akin to the PE 20, the BE 35, and the NG switch 40. Those skilled in the art will also understand that the components of each further sub-network may include other components such as access points, switches, a network management arrangement (NMA), etc. In addition, FIG. 1 including two EDs for each router 105, routers 210, routers 310 is only exemplary. That is, depending on a volume handling of each of the routers, further EDs may be associated therewith.

Those skilled in the art will understand that the above description of the network 10 including a variety of different transmission means indicate that the network 10 is an integrated network. Due to the variety of different transmission means and the respective components utilized therewith, conventional approaches to address issues that arise with the network 10 include multiple analyses to properly identify a source(s) that is causing, for example, a break in a signal transmission path. Technicians may be required to perform an analysis at each location in which a router is disposed to determine whether a component used for the signal transmission path is working properly.

According to the exemplary embodiments of the present invention, the CCE 15 may automate a process to determine a source in which an issue arises and also determine a solution to address the issue. As discussed above, each of the PEs 20, 25, 30, the BE 35 and the NG switch 40 may be connected to the CCE 15. Accordingly, the CCE 15 may directly analyze whether components directly associated (e.g., PEs 20, 25, 30, BE 35, NG switch 40) or indirectly associated (e.g., MR 100, EDs 110, ER 200, EDs 215, ER 300, EDs 315, TDM PBX 400, etc.) with the network 10 are functioning properly. The CCE 15 may include a database (not shown) that stores data relating to the network 10 including the transmission means used for each sub-network, the components used by each sub-network, etc.

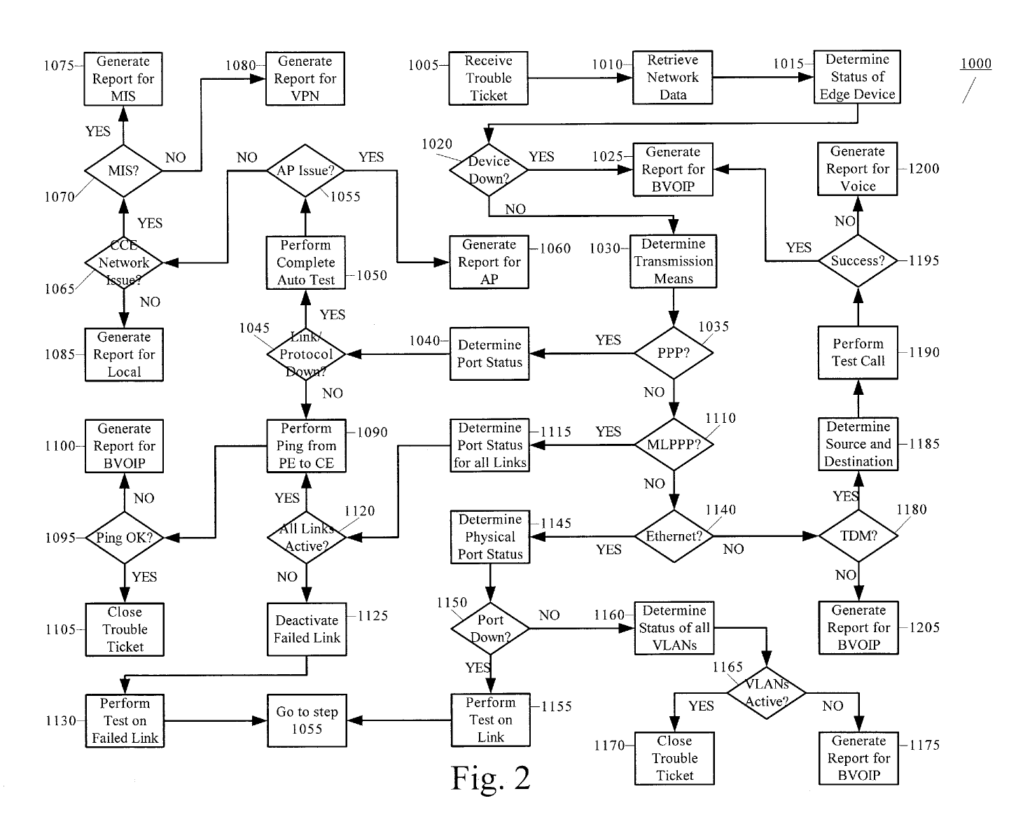

The CCE 15 may initially receive a trouble ticket from a technician relating to an issue that needs to be resolved. The trouble ticket may indicate a variety of facts relating to the issue. For example, the trouble ticket may indicate a time when the issue arose, an end user that reported the issue, a functionality attempted to be performed by the end user, etc. The CCE 15 may incorporate the data provided in the trouble ticket to resolve the reported issue. The technician may be required to input the data into the CCE 15. The method in which the CCE 15 resolves the issue will be discussed in further detail below with respect to FIG. 2.

It should be noted that the automated method used by the CCE 15 to determine the source of a network issue and to determine a solution to address the network issue being initially known via the trouble ticket is only exemplary. According to the exemplary embodiments of the present invention, the CCE 15 may perform tests to determine whether components of the network are functioning properly. For example, the CCE 15 may use pseudo signals for different types of voice services to be transmitted from a first component (e.g., ED 110) to a second component (e.g., ED 315). The CCE 15 may then test whether the pseudo signals properly reached its destination. The tests performed by the CCE 15 may be done to minimize network resources so that performance of voice services for users of the network 10 are not affected. In this manner, the CCE 15 may continuously oversee the proper functioning of the network 10. The tests may be performed at a variety of times. For example, the CCE 15 may perform the tests during down times when network resources may be used without affecting the users of the network 10. In another example, the CCE 15 may perform the tests at regular intervals such as at least once a day, once a week, once an hour, etc. In yet another example, the CCE 15 may perform the tests randomly.

FIG. 2 shows a method 1000 for an automated addressing of voice issues in an integrated network according to an exemplary embodiment of the present invention. The method 1000 may be designed to back track. That is, the method 1000 may initially determine whether a device disposed toward an edge is functioning properly. The method 1000 may subsequently continue to determine whether an “inner” device is functioning properly. However, those skilled in the art will understand that such a methodology is only exemplary. The method 1000 will be described with reference to the network 10, the sub-networks, and the respective components of FIG. 1. Because the CCE 15 may be connected to the PEs 20, 25, 30, the BE 35, and the NG switch 40, the CCE 15 may perform the method 1000.

It should be noted that the method 1000 may assume that the EDs 110, 215, 315 are functioning properly. An initial assessment may be performed by a technician or a user to determine that the ED is performing properly. If it is determined that the ED is not functioning properly, the method 1000 may not be necessary since fixing the problem at the ED may solve the issue reported by the user of the ED.

In step 1005, a trouble ticket is received. As discussed above, the trouble ticket may include data relating to the issue of the network 10. In a first exemplary embodiment, a technician may receive the trouble ticket from a user. Subsequently, the technician may input relevant data from the trouble ticket to the CCE 15. In a second exemplary embodiment, the user may fill a form for the trouble ticket. Subsequently, the CCE 15 may extract relevant data from the trouble ticket.

In step 1010, the CCE 15 retrieves network data. As discussed above, the CCE 15 may include a database relating to the network 10. In a first exemplary embodiment, the CCE 15 may retrieve only relevant data relating to the trouble ticket. For example, if the trouble ticket relates to the ED 215, the CCE 15 may retrieve data relating to the CLAN 205, components therein, and data relating to transmissions.

In step 1015, the CCE 15 determines a status of an edge device. The edge devices may include, for example, the ED 110, the ED 215, the ED 315, etc. As discussed above, the method 1000 may initially begin an analysis with outermost devices associated with the network 10. Therefore, the outermost devices may include the EDs 110, 215, 315.

In step 1020, the CCE 15 determines whether the status determined in step 1015 indicates that the edge device is down. If step 1020 determines that the edge device is down, the method 1000 continues to step 1025 where a report is generated for a branch voice over Internet protocol (BVOIP) work center. That is, since the source of the issue has been identified as the edge device indicated on the trouble ticket, the proper response may be performed by the BVOIP work center.

If step 1020 determines that the edge device is functioning properly, the method 1000 continues to step 1030 where the transmission means utilized by the edge router is determined. The transmission means may include, for example, a transport service, a provider edge router type, access tail technology, etc. The method 1000 continues to step 1035 where the CCE 15 determines if the transmission means determined in step 1030 indicates that a point-to-point protocol (PPP) is used by the edge router.

If step 1035 determines that a PPP is used, the method continues to step 1040 where the CCE 15 determines a status of the port related to the ED and the respective router. In step 1045, the CCE 15 determines whether the link and/or the protocol is down. If the link and/or the protocol is down, the method 1045 continues to step 1050 where a complete auto test is performed. The auto test (e.g., diagnostic) may include testing the edge router or any other network component functioning in a substantially similar manner, e.g., a network switch, an access point (AP), etc. That is, the auto test may indicate that an AP (or other edge device) issue is related to the network issue since the link and/or protocol relates directly to the AP.

Step 1055 determines whether the auto test performed in step 1050 indicates an AP issue. If step 1055 indicates that the issue relates to an AP issue, the method 1000 continues to step 1060 where a report is generated for an AP work center. Similar to the BVOIP work center, the proper response to an AP issue may be performed by the AP work center. If step 1055 indicates that the issue does not relate to an AP issue, the method 1000 continues to step 1065.

In step 1065, the CCE 15 determines whether the network issue is related with the components of the network 10 or with one of the sub-networks. If step 1065 determines that the network issue is with the network 10, then the method 1000 continues to step 1070. In step 1070, a determination is made whether the transmission means includes a managed internet service (“MIS”). If the transmission means is MIS, the method 1000 continues to step 1075 where a report is generated for a MIS work center. The proper response to an issue relating to MIS may be performed by the MIS work center. If the transmission means is not MIS, the method 1000 continues to step 1080 where a report is generated for a virtual private network (VPN) work center. The proper response to an issue relating to a different transmission means may be performed by the VPN work center.

Returning to step 1065, if step 1065 determines that the network issue is not related to the network 10, the method 1000 continues to step 1085 where a report is generated for a local work center related to the source of the trouble ticket (e.g., if the source is ED 315, the local work center may be an administrator of the OEM network 305).

Returning to step 1045, if step 1045 determines that the link and/or protocol is functioning properly, the method 1000 continues to step 1090 where a ping is performed from an inner component of the network 10 (e.g., PE 25) to a component of a sub-network (e.g., ER 200). Because the link and/or protocol for the PPP is functioning properly, the ping may be performed to determine, for example, latency issues.

In step 1095, the CCE 15 determines whether the ping performed in step 1090 is within predetermined parameters. The predetermined parameters may differ depending on the sub-network, the transmission means used by the sub-network, and other factors (e.g., distance). If the ping is determined to be within the predetermined parameters, the method 1000 continues to step 1105 where the trouble ticket is closed. That is, the CCE 15 determines that no issue exists between all the connections associated with a signal path for the source of the trouble ticket. If the ping is determined to be beyond the predetermined parameters, the method continues to step 1100 where a report is generated for the BVOIP work center. Again, the BVOIP work center may provide the appropriate response to an issue relating to a ping that is beyond the predetermined parameters.

Returning to step 1035, if step 1035 determines that the transmission means is not PPP, the method 1000 continues to step 1110 where a determination is made whether the transmission means is a multi-link (ML) PPP. If step 1110 determines that the transmission means is MLPPP, the method 1000 continues to step 1115. The mechanics of the MLPPP may be substantially similar to the PPP. Thus, in step 1115, CCE 15 determines a status of the ports. However, the CCE 15 determines the status for all links.

In step 1120, a determination is made whether all the links are functioning properly. If step 1120 determines that all the links are functioning properly, the method 1000 continues to step 1090 where a ping is performed. If step 1120 determines that all the links are not functioning properly, the method 1000 continues to step 1125 where the failed link(s) is deactivated. Subsequently, in step 1130, a diagnostic is performed on the failed link(s). Accordingly, the method 1000 may continue to step 1055 where the CCE 15 determines whether the network issue relates to an AP issue in the same manner as was described above.

Returning to step 1110, if step 1110 determines that the transmission means is also not MLPPP, the method 1110 continues to step 1140 where a determination is made whether the transmission means is an Ethernet protocol. If step 1140 determines that an Ethernet protocol is used, the method 1000 continues to step 1145 where the CCE 15 determines a status of a physical port used by the ED associated with the trouble ticket. Those skilled in the art will understand that the Ethernet protocol may include physical ports that receive, for example, wires (e.g., RJ45 heads) that connect components of the Ethernet.

In step 1150, a determination is made whether the status of the physical port determined in step 1145 indicates that the port is down. If the port is down, the method 1000 continues to step 1155 where a diagnostic is performed on the link. In a substantially similar manner as when step 1035 determines that the transmission means is PPP or when step 1110 determines that the transmission means is MLPPP, when the transmission means is an Ethernet protocol, the links may narrow a search criteria to determine a source of the network issue. Thus, upon completing the diagnostic in step 1155, the method 1000 continues to step 1055 where a determination is made whether the network issue is an AP issue.

Returning to step 1150, if step 1150 determines that the status of the physical port determined in step 1145 indicates that the port is functioning properly, the method 1000 continues to step 1160 where a determination is made for a status of all virtual LANs (VLAN). At this point in the analysis, the CCE 15 may determine that the connections of the components of the network 10 and the sub-network related to the trouble ticket may be functioning properly. Thus, the CCE 15 may conclude that the network issue may be related to the VLAN.

In step 1165, a determination is made whether the VLANs are active. If step 1165 determines that the VLANs are functioning properly, the CCE 15 closes the trouble ticket. That is, the source of the network issue does not relate to the connections of a transmission path nor does it relate to a configuration of the sub-network. If step 1165 determines that the VLANs are not functioning properly, the method 1000 continues to step 1175 where a report is generated for the BVOIP work center. Again, the BVOIP work center may provide an appropriate response related to VLANs (e.g., configuration issues such as virtual connections).

Returning to step 1140, if step 1140 determines that the transmission means is also not an Ethernet protocol, the method 1000 continues to step 1180 where a determination is made whether the transmission means relates to a TDM PBX. If step 1180 determines that the transmission means relates to the TDM PBX, the method 1000 continues to step 1185 where a source and a destination for the network issue is determined. Such data may be determined from the trouble ticket. For example, the source may be one of the EDs 315 while the destination may be another one of the EDs 315. In another example, the source may be one of the EDs 315 while the destination is one of the EDs 215. In yet another example, the source may be from the ED 510 while the destination may be one of the EDs 315.

In step 1190, the CCE 15 performs a test call to simulate as if an actual call is being placed from the source to the destination. As discussed above, the CCE 15 may be enabled to perform pseudo signal transmissions. Although the above discussed using these pseudo signal transmissions for automatically performing diagnostics without receiving a trouble ticket, a substantially similar process may be used to perform the test call in step 1190.

In step 1195, a determination is made whether the test call was performed successfully. If step 1195 determines that the test call was successful, the method 1000 continues to step 1025 where a report is generated for the BVOIP work center. That is, the test call indicates that the components of the network 10 and the sub-network are functioning properly. Thus, the network issue may relate to the TDM PBX. The BVOIP work center may provide the appropriate response to this type of network issue. If step 1195 determines that the test call was unsuccessful, the method 1000 continues to step 1200 where a report is generated for a voice work center. The voice work center may provide the appropriate response when the network issue relates to placing calls from a device within the network 10 or sub-network to another device within the network 10 or sub-network or to an outside device (e.g., via PSTN 500). The voice work center may also provide the appropriate response when the network issue relates to receiving call from a device from an outside device to a device within the network 10 or sub-network.

Returning to step 1180, if step 1180 determines that the transmission means is not a TDM PBX, the method 1000 continues to step 1205 where a report is generated for the BVOIP work center. Because determinations have been made that the edge router is functioning properly, the transmission means are neither PPP, MLPPP, Ethernet, nor TDM PBX, the report that is generated may merely indicate this information. A potential solution for the network issue may not relate to the rules used by the method 1000 to determine the source of the network issue.

It should be noted that the method 1000 may include additional steps. As discussed above, the CCE 15 may further determine potential solutions to the network issue upon determining the source of the network issue. For example, after step 1025 where the CCE 15 has been determined that the network issue relates to the edge router, the trouble ticket may further include data relating to the network issue that provides information to the CCE 15 to determine a solution to address the network issue. The method 1000 may include a step of providing solutions to the network issue after each step that generates a report to the appropriate work center.

The CCE 15 may be an intelligent device. Thus, upon each iteration of the method 1000, the database may be updated relating to each trouble ticket that has been addressed. With each update to the database, the CCE 15 may efficiently determine the source of the each subsequent network issue. Thus, the method 1000 may include a substep after step 1010 where the CCE 15 further determines whether a substantially similar trouble ticket was addressed previously. If a trouble ticket was addressed with substantially similar inputs as the current trouble ticket, the CCE 15 may bypass many steps to generate the report for the respective work center.

The method 1000 may also be adjusted so that the CCE 15 may determine a source for a network issue by incorporating more than one trouble ticket that is received. This may enable the CCE 15 to handle more than one trouble ticket per iteration of the method 1000. For example, EDs 215 from a common router 210 may both enter a trouble ticket relating to an identical network issue. By combining the trouble tickets, the CCE 15 is only required to run the method 1000 once. In another example, a first ED 215 from a first router 210 and a second ED 215 from a second router 210 may both enter a trouble ticket relating to a substantially similar network issue. The CCE 15 may narrow a search field to determine a source for the network issue such as the CCE 15 beginning a search with the ER 200. In such an example, the CCE 15 may bypass steps of the method 1000 such as step 1015-1025.

The exemplary embodiments of the present invention may provide a CCE for administrators of an integrated network to enable an automated means of determining a source of a network issue relating to voice services. Because the integrated network may incorporate a variety of different transmission means and components associated therewith, the CCE may also incorporate the various different types to narrow search fields and eventually determine the source of the network issue. The CCE may further be configured to determine a solution for the network issue. The solutions may be provided from standard solutions used by technicians that are stored in a database. The solutions may also be provided from recorded solutions used for similar trouble tickets that have been addressed in a prior iteration of the method according to the present invention.

It is also noted that the order of checking the various devices for their status provided in the above exemplary method may be altered to accomplish the same results. For example, the order in which the various protocols are checked may be altered depending on the particular network. In one example, the network administrator may be aware that the various sub-networks connected to the network may be weighted towards utilizing Ethernet protocols. Thus, the method described above may default to check for Ethernet protocols first. In a further example, the network administrator may be aware that there are no sub-networks utilizing Ethernet protocols. In this case, the Ethernet protocol check may be eliminated. Moreover, the list of protocols that are checked in the exemplary method is not meant to be exhaustive, but any type of protocol utilized by the sub-networks may be checked.

It is also noted that the service centers shown in the exemplary embodiments are only exemplary and that an individual network may utilize various types of service centers. These service centers may vary depending on the type of problem, the location of the problem, the identity of the customer experiencing the problem, etc.

Those skilled in the art will understand that the above described exemplary embodiments may be implemented in any number of manners, including, as a separate software module, as a combination of hardware and software, etc. For example, the CCE 15 may include a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method of determining a source of a network issue in a network connected to a plurality of sub-networks that utilize a plurality of transmission protocols, comprising:
receiving an indication of the network issue, the network issue relating to a malfunction of a voice service provided by the network; and
determining a source of the network issue by determining a status for each of select components impacted by the network issue, the select components being determined by a type of the transmission protocols related to the network issue.

2. The method of claim 1, further comprising:
providing at least one solution to address the network issue upon determining the source.

3. The method of claim 1, wherein the indication is a trouble ticket received from one of a user reporting the network issue and a technician assigned to the network issue.

4. The method of claim 1, wherein the malfunction of a voice service relates to a transmission path for signals from a first end device to a second end device.

5. The method of claim 1, wherein the select components are deployed in one of the network and the sub-networks.

6. The method of claim 5, further comprising:
determining the source of the network issue relates to an edge device of the PSTN.

7. The method of claim 1, wherein the network includes edge devices, each edge device being an intermediary to one of the sub-networks.

8. The method of claim 7, wherein each of the edge devices is one of a provider edge device, a branch exchange device, and a network gateway switch.

9. The method of claim 8, wherein the sub-networks include a local area network (LAN), a customer LAN, an optical Ethernet mesh (OEM) network, a time division multiplexing private branch exchange (TDM PBX), a wireless network, and a private LAN.

10. The method of claim 1, wherein each of the transmission protocols is one of a digital subscriber line (DSL), a management information system (MIS) protocol, a virtual private network (VPN) protocol, and a proprietary protocol.

11. A system, comprising:
an analysis device of an network adapted to receive an indication of a network issue, the network issue relating to a malfunction of a voice service provided by the network; and
a plurality of edge devices of the network, each edge device being connected to a sub-network device of a sub-network associated with the network, each sub-network utilizing a transmission protocol,
wherein the analysis device determines a source of the network issue by determining a status of each of select devices impacted by the network issue, the select devices being determined by a type of the transmission protocol related to the network issue.

12. The system of claim 11, wherein the analysis device provides at least one solution to address the network issue upon determining the source.

13. The system of claim 11, wherein the indication is a trouble ticket received from one of a user reporting the network issue and a technician assigned to the network issue.

14. The system of claim 11, wherein the malfunction of a voice service relates to a transmission path for signals from a first end device to a second end device.

15. The system of claim 11, wherein the select devices include one of the edge devices and the sub-networks devices.

16. The system of claim 15, wherein the analysis device determines the source of the network issue relates to an edge device of the PSTN.

17. The system of claim 11, wherein the edge device is one of a provider edge device, a branch exchange device, and a network gateway switch.

18. The system of claim 11, wherein the sub-networks include a LAN, a customer LAN, an OEM network, a TDM PBX, a wireless network, and a private LAN.

19. The system of claim 11, wherein each of the transmission protocols is one of a DSL, a MIS protocol, a VPN protocol, and a proprietary protocol.

20. A computer readable storage medium including a set of instructions executable by a processor to determine a source of a network issue in a network connected to a plurality of sub-networks that utilize a plurality of transmission protocols, the set of instructions being operable to:
receive an indication of the network issue, the network issue relating to a malfunction of a voice service provided by the network; and
determine a source of the network issue by determining a status for each of select components impacted by the network issue, the select components being determined by a type of the transmission protocols related to the network issue.
